(19) United States
(12) Patent Application Publication
(10) Pub. No.: US 2009/0066980 A1
(43) Pub. Date: Mar. 12, 2009

(54) IMAGE FORMING APPARATUS AND CONTROL METHOD OF THE SAME

(75) Inventor: Eiji Shinohara, Shizuoka (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/207,204

(22) Filed: Sep. 9, 2008

Related U.S. Application Data
(60) Provisional application No. 60/971,546, filed on Sep. 11, 2007.

(51) Int. Cl. G06F 15/00

(52) U.S. Cl. 358/1.9

(57) ABSTRACT

The numbers of pixels of respective colors of image data are detected. In monochrome printing, a print invalid area with first variable width corresponding to the number of black pixels among the detected numbers of pixels of the respective colors is set in a top portion of the image data. In color printing, a print invalid area with second variable width corresponding to a sum of the detected numbers of pixels of the respective colors in the top portion of the image data.

### CROSS-REFERENCE TO RELATED APPLICATION

This application is based upon and claims the benefit of priority from U.S. Provisional Application No. 60/971,546 filed on Sep. 11, 2007, the entire contents of which are incorporated herein by reference.

### TECHNICAL FIELD

The present invention relates to an image forming apparatus and a control method of the same that take into account a void of a paper sheet on which an image is printed.

### BACKGROUND

An image forming apparatus that can perform monochrome printing and color printing includes photoconductive drums for yellow, magenta, cyan, and black as image bearing members and also includes a transfer belt as an image bearing member. Further, the image forming apparatus includes an exposing unit, plural developing units, plural primary transfer rollers, a secondary transfer roller, and a fixing roller.

The exposing unit exposes the surfaces of the photoconductive drums with laser beams to thereby form electrostatic latent images on the surfaces of the photoconductive drums, respectively. The developing units develop the electrostatic latent images formed on the surfaces of the photoconductive drums with a yellow developer, a magenta developer, a cyan developer, and a black developer to visualize the electrostatic latent images, respectively. The transfer belt rotates while coming into contact with the surfaces of the respective photoconductive drums. The primary transfer rollers rotate while pressing the transfer belt against and bringing the same into contact with the surfaces of the photoconductive drums to thereby transfer visible images on the photoconductive drums onto the transfer belt, respectively. The secondary transfer roller transfers the visible images of the respective colors transferred onto the transfer belt onto a paper sheet. The fixing roller applies heat to the paper sheet having the visible images transferred thereon to fix the visible images on the paper sheet. Printing of an image is completed by the fixing of the visible images.

Paper sheets are stored in at least one paper feeding cassette. A conveying path for the paper sheets is provided from the paper feeding cassette to the secondary transfer roller. A pickup roller and a paper feeding roller are provided in positions opposed to the paper feeding cassette. The pickup roller extracts one paper sheet in the paper feeding cassette. The paper feeding roller delivers the paper sheet extracted by the pickup roller to the conveying path. The paper sheet delivered to the conveying path reaches registration rollers. The registration rollers once put the paper sheet on standby and feed the paper sheet into between the transfer belt and the secondary transfer roller at timing when a top position of the visible images on the transfer belt and a leading end of the paper sheet coincide with each other. The visible images on the transfer belt are transferred onto the paper sheet fed into between the transfer belt and the secondary transfer roller.

In such an image forming apparatus, a paper jam in which the leading end of the paper sheet twines around the transfer belt without separating from the transfer belt because of adhesion of developers present at the leading end of the paper sheet occurs.

To cope with such a deficiency, for example, in JP-A-2000-47515, a void to which the developers do not adhere is secured at the leading end of the paper sheet.

### SUMMARY

However, an amount of developers adhering to the paper sheet is different in monochrome printing and color printing.

Therefore, it is impossible to surely prevent, simply by securing the void at the leading end of the paper sheet, the paper jam in which the leading end of the paper sheet twines around the transfer belt without separating from the transfer belt.

It is an object of an aspect of the present invention to provide an image forming apparatus and a control method thereof that can surely prevent a paper jam in which a leading end of a paper sheet twines around an image bearing member without separating from the image bearing member.

An image forming apparatus according to an aspect of the present invention includes: a process unit which includes image bearing members, has a function of monochrome printing for forming latent images corresponding to inputted image data on the image bearing members, developing the latent images on the image bearing members with a black developer, and transferring the developed images onto a leading end to a trailing end of a paper sheet, and has a function of color printing for forming latent images corresponding to the image data on the image bearing members, developing the latent images on the image bearing members with developers of plural colors, and transferring the developed latent images onto the leading end to the trailing end of the paper sheet; a detecting section which detects the number of pixels of the image data; a first control section which sets, in the monochrome printing, a print invalid area with first variable-width corresponding to a detection result of the detecting section in a top portion of the image data; and a second control section which sets, in the color printing, a print invalid area with second variable-width corresponding to a detection result of the detecting section in the top portion of the image data.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing a general configuration of embodiments of the present invention;

FIG. 2 is a diagram showing a configuration around each of photoconductive drums shown in FIG. 1;

FIG. 3 is a diagram showing a state of a paper sheet passing between a transfer belt and a secondary transfer roller shown in FIG. 1;

FIG. 4 is a block diagram showing a control circuit according to the embodiments;

FIG. 5 is a block diagram showing an exposing unit shown in FIG. 1;

FIG. 6 is a flowchart for explaining actions in a first embodiment of the present invention;

FIG. 7 is a diagram showing image data for one page and a count area for pixels in a top portion of the image data in the first embodiment;

FIG. 8 is a diagram showing a void secured at a leading end of a paper sheet in monochrome printing according to the embodiments;

FIG. 9 is a diagram showing a void secured at a leading end of a paper sheet in color printing according to the embodiments; and

FIG. 10 is a flowchart for explaining actions of a second embodiment of the present invention.

### DETAILED DESCRIPTION

A first embodiment of the present invention is explained below with reference to the accompanying drawings.

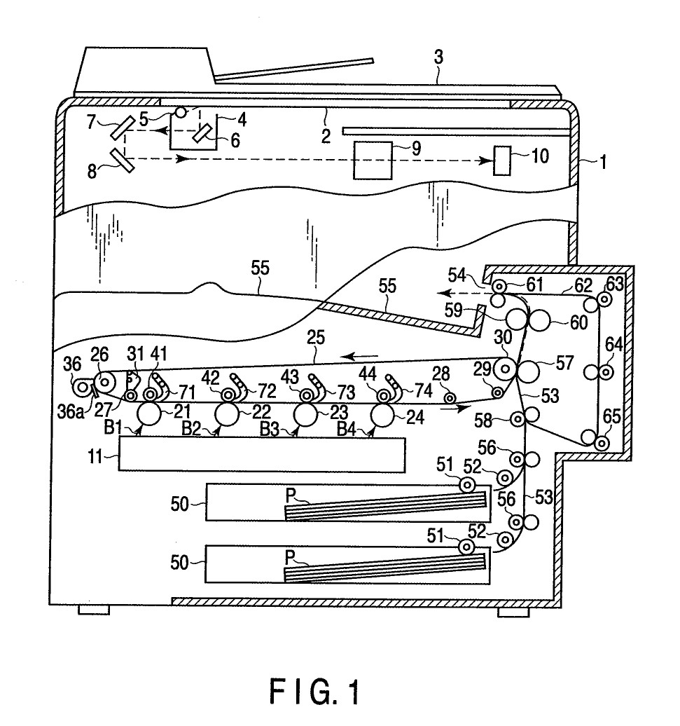

As shown in FIG. 1, a transparent original glass (a glass plate) 2 for placing an original is provided in an upper part of a main body 1. A cover 3 is openably and closably provided on the original glass 2. A carriage 4 is provided on a lower surface side of the original glass 2. An exposure lamp 5 is provided in the carriage 4. The carriage 4 can reciprocatingly move along the lower surface of the original glass 2. The exposure lamp 5 is turned on while the carriage 4 is moving forward, whereby an original D on the original glass 2 is exposed to light. A reflected light image of the original D on the original glass 2 is obtained by the exposure. The reflected light image is projected on a CCD (Charge Coupled Device) 10 by reflection mirrors 6, 7, and 8 and a magnification lens block 9. The CCD 10 outputs an image signal of a level corresponding to the reflected light image of the original D.

A scanning unit that optically scans an image of the original D placed on the original glass 2 is configured by the carriage 4, the exposure lamp 5, the reflection mirrors 6, 7, and 8, the magnification lens block 9, and the CCD 10.

Image signals outputted from the CCD 10 are supplied to an exposing unit 11 after being appropriately processed. The exposing unit 11 emits a laser beam B1 corresponding to a yellow image signal, a laser beam B2 corresponding to a magenta image signal, a laser beam B3 corresponding to a cyan image signal, and a laser beam B4 corresponding to a black image signal to a photoconductive drum 21 for yellow, a photoconductive drum 22 for magenta, a photoconductive drum 23 for cyan, and a photoconductive drum 24 for black, respectively.

The photoconductive drums 21, 22, 23, and 24 are arrayed in a substantially horizontal direction at fixed intervals. A transfer belt 25 is provided above the photoconductive drums 21, 22, 23, and 24. The transfer belt 25 is laid over a drive roller 26, guide rollers 27, 28, and 29, and a driven roller 30. The transfer belt 25 receives power from the drive roller 26 and rotates in the counterclockwise direction. The guide roller 27 is provided to freely move up and down. The guide roller 27 receives the rotational motion of a cam (a third cam) 31 and moves to the photoconductive drum 21 side to thereby displace the transfer belt 25 to the photoconductive drums 21, 22, 23, and 24 side.

Primary transfer rollers 41, 42, 43, and 44 are provided to freely move up and down in positions opposed to the photoconductive drums 21, 22, 23, and 24, respectively. The primary transfer rollers 41, 42, 43, and 44 are displaced (lowered) to the transfer belt 25 side to thereby rotate while pressing the transfer belt 25 against and bringing the same into contact with the photoconductive drums 21, 22, 23, and 24 and transfer visible images on the photoconductive drums 21, 22, 23, and 24 onto the transfer belt 25.

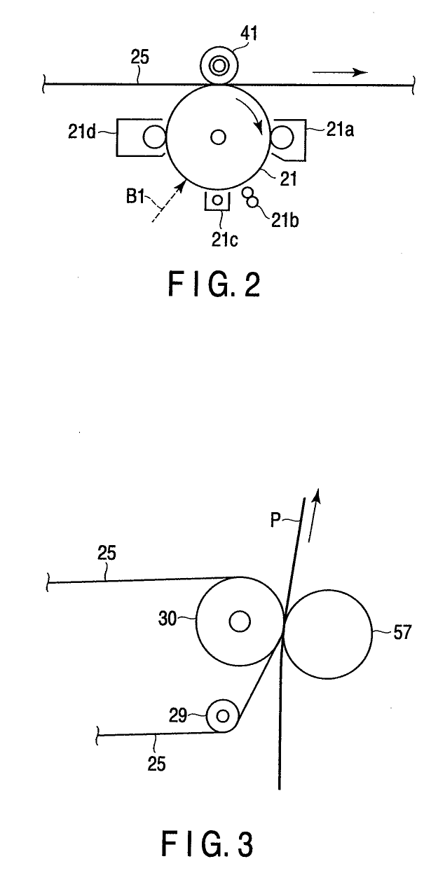

The photoconductive drum 21 and a configuration of the periphery thereof are shown in FIG. 2. A cleaner 21a, a charge removing lamp 21b, an exposing unit 21c, and a yellow developing unit 21d are sequentially disposed around the photoconductive drum 21. The cleaner 21a removes a developer remaining on the surface of the photoconductive drum 21. The charge removing lamp 21b removes electric charge remaining on the surface of the photoconductive drum 21. The charging unit 21c applies high voltage to the photoconductive drum 21 to thereby charge the surface of the photoconductive drum 21 with static electric charge. The laser beam B1 emitted from the exposing unit 11 is irradiated on the surface of the photoconductive drum 21 subjected to the charging. An electrostatic latent image is formed on the surface of the photoconductive drum 21 by the irradiation of the laser beam B1. The developing unit 21d supplies a yellow developer (toner) to the surface of the photoconductive drum 21 to thereby develop the electrostatic latent image on the surface of the photoconductive drum 21 in yellow and visualize the same.

The other photoconductive drums 22, 23, and 24 and a configuration of the peripheries thereof are the same as the above. Therefore, explanation of the photoconductive drums 22, 23, and 24 and the configuration is omitted.

Plural paper feeding cassettes 50 are provided below the exposing unit 11. The paper feeding cassettes 50 store a large number of paper sheets P of sizes different from one another. Pickup rollers 51 and paper feeding rollers 52 are provided in positions opposed to the paper feeding cassettes 50, respectively. Each of the pickup rollers 51 extracts one paper sheet P from each of the paper feeding cassettes 50. Each of the paper feeding rollers 52 delivers the paper sheet P extracted by the pickup roller 51 to a conveying path 53. The conveying path 53 extends to a paper discharge port 54 in an upper part through a position opposed to the driven roller 30. The paper discharge port 54 faces a paper discharge tray 55 that continues to an outer peripheral surface of the main body 1.

Conveying rollers 56 are provided near the paper feeding rollers 52, respectively. A secondary transfer roller 57 is provided in a position opposed to the driven roller 30 in the conveying path 53 across the transfer belt 25. Registration rollers 58 are provided in a position before the driven roller 30 and the secondary transfer roller 57. The registration rollers 58 once put the paper sheet P fed by one of the conveying rollers 56 on standby and feed the paper sheet P into between the transfer belt 25 and the secondary transfer roller 57 at timing when a top position of the visible images on the transfer belt 25 and a leading end of the paper sheet P coincide with each other. The secondary transfer roller 57 transfers the visible images transferred on the transfer belt 25 onto the paper sheet P.

A state of the paper sheet P passing between the transfer belt 25 and the secondary transfer roller 57 is shown in FIG. 3.

In the conveying path 53, a heat roller 59 for heat fixing and a press-contact roller 60 set in contact with the heat roller 59 are provided in a position further on a downstream side than the secondary transfer roller 57. Paper discharge rollers 61 are provided at a terminal end of the conveying path 53.

A conveying path 62 for reversing the front and the back of the paper sheet P is provided from the terminal end of the conveying path 53 to a position on an upstream side of the registration roller 58. Paper feeding rollers 63, 64, and 65 are provided in the conveying path 62. The paper sheet P that reaches the terminal end of the conveying path 53 is returned to the conveying path 53 through the conveying path 62, whereby the visible images on the transfer belt 25 are transferred onto a rear surface of the paper sheet P as well.

On the other hand, a cleaner 36 is provided in a position opposed to the drive roller 26 across the transfer belt 25. The cleaner 36 has a cleaning blade 36a set in contact with the transfer belt 25 and removes a developer remaining on the transfer belt 25.

Hooks 71, 72, 73, and 74 are provided near the primary transfer rollers 41, 42, 43, and 44. The hooks 71, 72, 73, and 74 lift shafts of the primary transfer rollers 41, 42, 43, and 44 and displace the primary transfer rollers 41, 42, 43, and 44 upward. The transfer belt 25 is separated from the surfaces of the photoconductive drums 21, 22, 23, and 24 by the displacement. The hooks 71, 72, 73, and 74 pivot during operation and lift the shafts of the primary transfer rollers 41, 42, 43, and 44. The hooks 71, 72, 73, and 74 return during non-operation and release the lifting of the primary transfer rollers 41, 42, 43, and 44. When the shafts of the primary transfer rollers 41, 42, 43, and 44 are lifted, the primary transfer rollers 41, 42, 43, and 44 are displaced upward and the transfer belt 25 is separated from the surfaces of the photoconductive drums 21, 22, 23, and 24. When the lifting of the primary transfer rollers 41, 42, 43, and 44 is released, the primary transfer rollers 41, 42, 43, and 44 are displaced downward and the transfer belt 25 is pressed against and brought into contact with the surfaces of the photoconductive drums 21, 22, 23, and 24.

After transferring the visible images of the respective colors onto the paper sheet P, the transfer belt 25 continues the rotation until developers remaining thereon are removed by the cleaner 36. However, when the transfer belt 25 continues the rotation while coming into contact with the photoconductive drums 21, 22, 23, and 24, the surfaces of the photoconductive drums 21, 22, 23, and 24 are worn and the durable life of the photoconductive drums 21, 22, 23, and 24 is reduced. Therefore, after the visible images on the transfer belt 25 are transferred onto the paper sheet P, the primary transfer rollers 41, 42, 43, and 44 are displaced upward to separate the transfer belt 25 from the surfaces of the photoconductive drums 21, 22, 23, and 24. After the developers remaining on the transfer belt 25 are removed by the cleaner 36, the primary transfer rollers 41, 42, 43, and 44 are displaced downward to bring the transfer belt 25 into contact with the photoconductive drums 21, 22, 23, and 24.

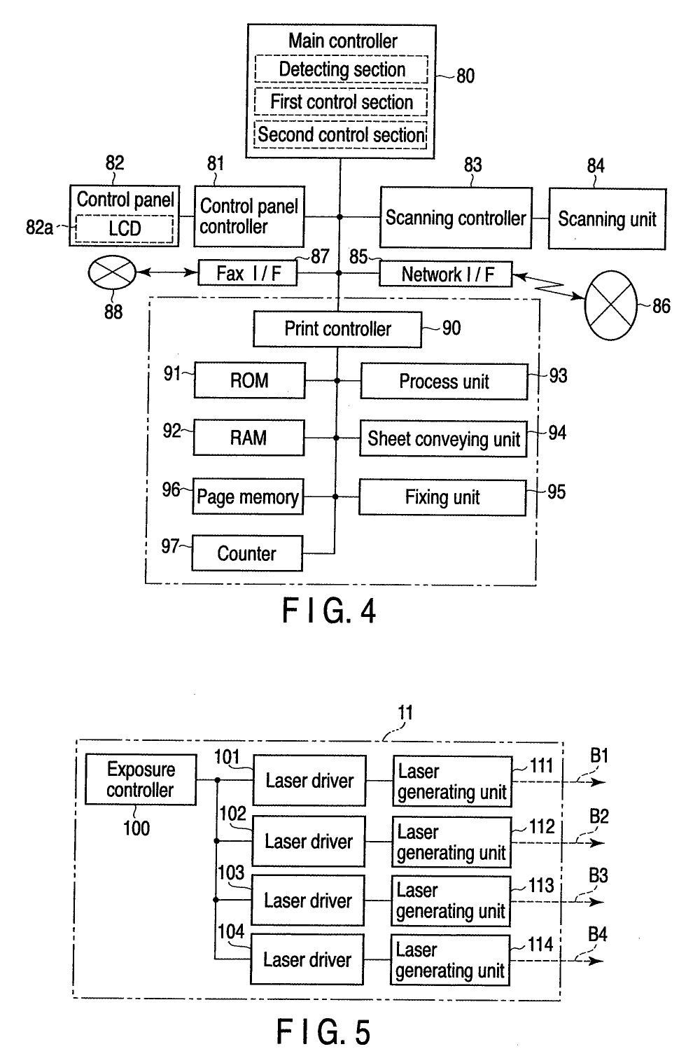

A control circuit of a main body 1 is shown in FIG. 4.

A control panel controller 81, a scanning controller 83, a network interface 85, a facsimile interface 87, and a print controller 90 are connected to a main controller 80.

The control panel controller 81 controls a control panel 82 for setting operation conditions. The control panel 82 has an LCD 82a as a display unit. The scanning controller 83 controls a scanning unit 84. The scanning unit 84 includes the original glass 2, the cover 3, the carriage 4, the exposure lamp 5, the reflection mirrors 6, 7, and 8, the magnification lens block 9, and the CCD 10. The scanning unit 84 scans an image of an original set on the original glass 2 through optical main scanning and sub-scanning. Image data obtained by the scanning operation of the scanning unit 84 is stored in a RAM 92.

The network interface 85 is connected to a communication network 86. The facsimile interface 87 is connected to a communication line 88. Image data inputted through the network interface 85 and the facsimile interface 87, respectively, are also stored in the RAM 92.

A ROM 91 for storing a control program, a RAM 92 for storing data, a process unit 93, a sheet conveying unit 94, a fixing unit 95, a page memory 96, and a counter 97 are connected to the print controller 90. The fixing unit 95 includes the heat roller 59 and the press-contact roller 60. The page memory 96 stores image data for one page among the image data stored in the RAM 92 as image data for printing while sequentially updating the same. The counter 97 is prepared for counting the numbers of pixels of the image data stored in the page memory 96.

The process unit 93 includes the exposing unit 11, the photoconductive drums 21, 22, 23, and 24, the configuration of the peripheries of the photoconductive drums shown in FIG. 2, the transfer belt 25, the drive roller 26, the guide rollers 27, 28, and 29, the driven roller 30, the primary transfer rollers 41, 42, 43, and 44, the secondary transfer roller 57, and the hooks 71, 72, 73, and 74. The process unit 93 exposes the photoconductive drums 21, 22, 23, and 24 through main scanning and sub-scanning by laser beams to thereby print image data scanned by the scanning unit 84 or image data inputted from the outside on the paper sheet P.

In particular, the process unit 93 has a function of monochrome printing for forming electrostatic latent images corresponding to the image data stored in the page memory 96 on the photoconductive drums 21, 22, 23, and 24 through main scanning and sub-scanning by laser beams, developing the electrostatic latent images on the photoconductive drums 21, 22, 23, and 24 with a black developer, and transferring the developed images onto a leading end to a trailing end of the paper sheet P. The process unit 93 also has a function of color printing for forming electrostatic latent images corresponding to the image data stored in the page memory 96 on the photoconductive drums 21, 22, 23, and 24 through main scanning and sub-scanning by a laser beam, developing the electrostatic latent images on the photoconductive drums 21, 22, 23, and 24 with developers of plural colors (yellow, magenta, cyan, and black), and transferring the developed images onto the leading end to the trailing end of the paper sheet P.

A configuration of the exposing unit 11 is shown in FIG. 5. The exposing unit 11 includes an exposure controller 100, laser drivers 101, 102, 103, and 104, and laser generating units 111, 112, 113, and 114. The exposing unit 11 exposes the surfaces of the photoconductive drums 21, 22, 23, and 24 through main scanning and sub-scanning by laser beams emitted from the laser generating units 111, 112, 113, and 114 to thereby form electrostatic latent images corresponding to the image data stored in the page memory 96 on the photoconductive drums 21, 22, 23, and 24.

The main controller 80 has sections described in (1) to (3) below as main functions concerning printing.

(1) A detecting section that detects the numbers of pixels of the respective colors in a top portion of the image data for one page stored in the page memory 96. Specifically, the detecting section counts the number of yellow pixels, the number of magenta pixels, the number of cyan pixels, and the number of black pixels in the top portion of the image data stored in the page memory 96 using the counter 97.

(2) A first control section that sets, in the monochrome printing, a print invalid area with first variable width D1 corresponding to the number of black pixels among the numbers of pixels of the respective colors detected by the detecting section in the top portion of the image data stored in the page memory 96. The print invalid area with the first variable width D1 is an area for forming a void area, to which the black developer (a black toner) does not adhere, at the leading end of the paper sheet P. The print invalid area with the first variable width D1 includes a print invalid area with reference width D0 for forming a necessary minimum void area at the leading end of the paper sheet P. A width direction of the print invalid areas corresponds to a direction of sub-scanning of the laser beams in the process unit 93.

(3) A second control section that sets, in the color printing, a print invalid area with second variable width D2 corresponding to a sum of the numbers of pixels of the respective colors detected by the detecting section in the top portion of the image data stored in the page memory 96. The print invalid area with the second variable width D2 is an area for forming a void area, to which the developers of the respective colors (a yellow toner, a magenta toner, a cyan toner, and a black toner) do not adhere, at the leading end of the paper sheet P. The print invalid area with the second variable width D2 includes the print invalid area with the reference width D1.

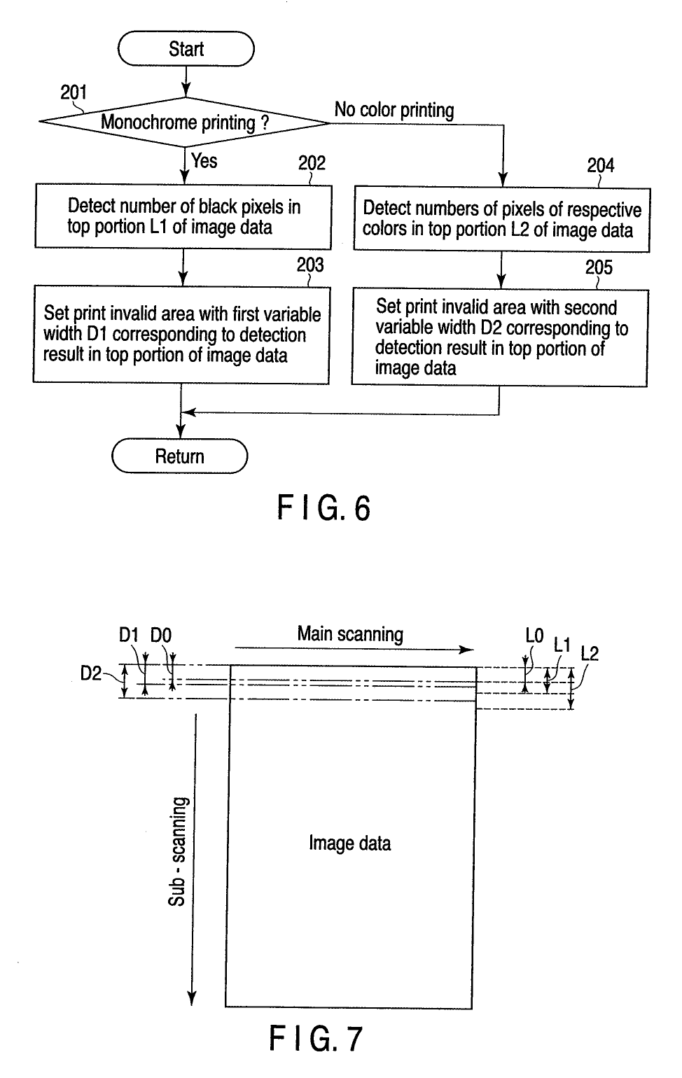

Actions are explained with reference to a flowchart shown in FIG. 6.

When a start key of the control panel 82 is turned on, an image of an original placed on the original glass 2 is scanned by the scanning unit 84. The scanned image is stored in the RAM 92 as image data. Image data inputted to the network interface 85 or image data inputted through the facsimile interface 87 is also stored in the RAM 92.

Image data for one page among the image data stored in the RAM 92 is stored in the page memory 96 as image data for printing.

In the monochrome printing (YES in Act 201), the main controller 80 detects the number of black pixels in a top portion of the image data stored in the page memory 96, for example, the number of black pixels in an area with width L1 from the top of the image data as shown in FIG. 7 (Act 202). The detected number of black pixels corresponds to a visible image transferred onto the paper sheet P, i.e., an amount of the black developer (the black toner). The width L1 includes reference width L0 for setting a necessary minimum void area in the paper sheet P.

When the number of black pixels is detected, the main controller 80 sets a print invalid area with first variable width D1 corresponding to a result of the detection in the top portion of the image data stored in the page memory 96 (Act 203). As the number of black pixels is larger, a print invalid area with larger first variable width D1 is set.

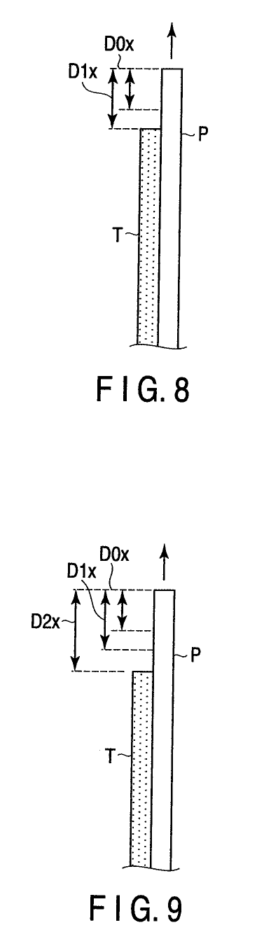

When the print invalid area with the first variable width D1 is set, as shown in FIG. 8, a void area with width D1x, to which an image T formed by the black developer (the black toner) does not adhere, is formed at the leading end of the paper sheet P. As the print invalid area with the first variable width D1 is larger, the void area with the width D1x is also larger. The void area with the width D1x includes a void area with necessary minimum reference width D0x.

When the number of black pixels in the top portion of the image data is large, an amount of the black developer present at the leading end of the paper sheet P increases and the leading end of the paper sheet P easily adheres to the transfer belt 25. Taking this point into account, the width of the void area at the leading end of the paper sheet P is increased. When the width of the void area is increased, the leading end of the paper sheet P less easily adheres to the transfer belt 25. Therefore, it is possible to surely prevent a paper jam in which the leading end of the paper sheet P twines around the transfer belt 25 without separating from the transfer belt 25.

When the number of the black pixels in the top portion of the image data is small, the amount of the black developer present in the leading end of the paper sheet P decreases and the leading end of the paper sheet P hardly adheres to the transfer belt 25. Taking this point into account, the width of the void area at the leading end of the paper sheet P is reduced as much as possible. When the width of the void area is reduced, the leading end of the paper sheet P does not twine around the transfer belt 25. Moreover, it is possible to print an image in as wide an area as possible of the paper sheet P.

On the other hand, in the color printing (NO in Act 201), the main controller 80 detects a sum of the numbers of pixels of the respective colors in the top portion of the image data stored in the page memory 96, for example, a sum of the numbers of pixels of the respective colors in an area of width L2 from the top of the image data shown in FIG. 7 (Act 204). The detected sum of the numbers of pixels of the respective colors corresponds to visible images transferred onto the paper sheet P, i.e., a sum of an amount of a yellow developer (a yellow toner), an amount of a magenta developer (a magenta toner), an amount of a cyan developer (a cyan toner), and an amount of a black developer (a black toner). The width L2 is larger than the width L1 in the monochrome printing.

When the sum of the numbers of pixels of the respective colors is detected, the main controller 80 sets a print invalid area with second variable width D2 corresponding to a result of the detection in the top portion of the image data stored in the page memory 96 (Act 205). As the sum of the numbers of pixels of the respective colors is larger, a print invalid area with larger second variable width D2 is set.

When the print invalid area with the second variable width D2 is set, as shown in FIG. 9, a void area with width D2x, to which an image T formed by the developers of the respective colors does not adhere, is formed at the leading end of the paper sheet P. When the print invalid area with the second variable width D2 is large, the void area with the width D2x is also large. The void area with the width D2x includes the void area with the width D1x in the monochrome printing.

When the sum of the numbers of pixels of the respective colors in the top portion of the image data is large, amounts of the developers of the respective colors present at the leading end of the paper sheet P increase and the leading end of the paper sheet P easily adheres to the transfer belt 25. Taking this point into account, the width of the void area at the leading end of the paper sheet P is increased. When the width of the void area is increased, the leading end of the paper sheet P easily adheres to the transfer belt 25. Therefore, it is possible to surely prevent the paper jam in which the leading end of the paper sheet P twines around the transfer belt 25 without separating from the transfer belt 25.

In particular, in the color printing, an amount of adhesion of the developers is larger than that in the monochrome printing. Taking this point into account, the width of the void area is set larger than that in the monochrome printing. In this regard, likewise, it is possible to surely prevent the paper jam in which the leading end of the paper sheet P twines around the transfer belt 25 without separating from the transfer belt 25.

When the number of the black pixels in the top portion of the image data is small, the amounts of the developers of the respective colors present at the leading end of the paper sheet P decrease and the leading end of the paper sheet P hardly adheres to the transfer belt 25. Taking this point into account, the void area at the leading end of the paper sheet P is reduced as much as possible. When the width of the void area is reduced, the leading end of the paper sheet P does not twine around the transfer belt 25. Moreover, it is possible to print an image in as wide an area as possible of the paper sheet P.

When the printing of the image data for one page is completed, image data for the next one page is read out from the RAM 92 and updated and stored in the page memory 96. Processing same as above is executed on the image data stored in the page memory 96.

A second embodiment of the present invention is explained.

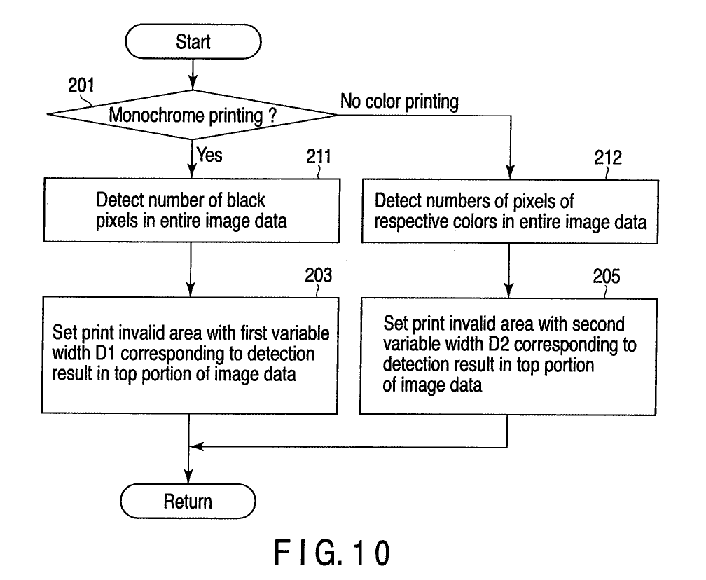

As indicated by a flowchart shown in FIG. 10, processing in Acts 211 and 212 is adopted instead of the processing in Acts 202 and 204 in the first embodiment.

In monochrome printing, the main controller 80 detects the number of black pixels in the entire image data stored in the page memory 96 (Act 211). In color printing, the main controller 80 detects a sum of the numbers of pixels of the respective colors in the entire image data stored in the page memory 96 (Act 212).

Other actions and effects are the same as those in the first embodiment. Therefore, explanation of the actions and effects is omitted.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming apparatus comprising:
a process unit which includes image bearing members, has a function of monochrome printing for forming latent images corresponding to inputted image data on the image bearing members, developing the latent images on the image bearing members with a black developer, and transferring the developed images onto a leading end to a trailing end of a paper sheet, and has a function of color printing for forming latent images corresponding to the image data on the image bearing members, developing the latent images on the image bearing members with developers of plural colors, and transferring the developed latent images onto the leading end to the trailing end of the paper sheet;
a detecting section which detects numbers of pixels of the respective colors of the image data;
a first control section which sets, in the monochrome printing, a print invalid area with first variable-width corresponding to a number of black pixels among the numbers of pixels of the respective colors detected by the detecting section in a top portion of the image data; and
a second control section which sets, in the color printing, a print invalid area with second variable-width corresponding to a sum of the numbers of pixels of the respective colors detected by the detecting section in the top portion of the image data.

2. The apparatus according to claim 1, wherein the detecting section detects numbers of pixels of the respective colors in a top portion of the image data.

3. The apparatus according to claim 2, wherein
the print invalid area with the first variable width forms a void area, to which the black developer does not adhere, at the leading end of the paper sheet, and
the print invalid area with the second variable width forms a void area, to which the developers of the plural colors do not adhere, at the leading end of the paper sheet.

4. The apparatus according to claim 2, wherein the process unit has a function of monochrome printing for forming latent images corresponding to the image data on the image bearing members through optical main scanning and sub-scanning, developing the latent images on the image bearing members with the black developer, and transferring the developed images onto the leading end to the trailing end of the paper sheet, and has a function of color printing for forming latent images corresponding to the image data on the image bearing members through optical main scanning and sub-scanning, developing the latent images on the image bearing members with the developers of the plural colors, and transferring the developed latent images onto the leading end to the trailing end of the paper sheet.

5. The apparatus according to claim 4, wherein a width direction of the print invalid area corresponds to a direction of the sub-scanning by the process unit.

6. The apparatus according to claim 2, wherein the image bearing members are a photoconductive drum for yellow, a photoconductive drum for magenta, a photoconductive drum for cyan, a photoconductive drum for black, and a transfer belt which rotates while coming into contact with the photoconductive drums.

7. The apparatus according to claim 2, further comprising a counter for counting numbers of pixels of the respective colors.

8. The apparatus according to claim 7, wherein the detecting section counts numbers of pixels of the respective colors in the top portion of the image data using the counter.

9. The apparatus according to claim 7, wherein the detecting section counts a number of yellow pixels, a number of magenta pixels, a number of cyan pixels, and a number of black pixels in the top portion of the image data using the counter.

10. The apparatus according to claim 1, wherein the detecting section detects numbers of pixels of the respective colors in the entire image data.

11. The apparatus according to claim 10, wherein
the print invalid area with the first variable width forms a void area, to which the black developer does not adhere, at the leading end of the paper sheet, and
the print invalid area with the second variable width forms a void area, to which the developers of the plural colors do not adhere, at the leading end of the paper sheet.

12. The apparatus according to claim 10, wherein the process unit has a function of monochrome printing for forming latent images corresponding to the image data on the image bearing members through optical main scanning and sub-scanning, developing the latent images on the image bearing members with the black developer, and transferring the developed images onto the leading end to the trailing end of the paper sheet, and has a function of color printing for forming latent images corresponding to the image data on the image bearing members through optical main scanning and sub-scanning, developing the latent images on the image bearing members with the developers of the plural colors, and transferring the developed latent images onto the leading end to the trailing end of the paper sheet.

13. The apparatus according to claim 12, wherein a width direction of the print invalid area corresponds to a direction of the sub-scanning by the process unit.

14. The apparatus according to claim 12, wherein the image bearing members are a photoconductive drum for yellow, a photoconductive drum for magenta, a photoconductive drum for cyan, a photoconductive drum for black, and a transfer belt which rotates while coming into contact with the photoconductive drums.

15. The apparatus according to claim 10, further comprising a counter for counting numbers of pixels of the respective colors.

16. The apparatus according to claim 15, wherein the detecting section counts numbers of pixels of the respective colors in the top portion of the image data using the counter.

17. The apparatus according to claim 15, wherein the detecting section counts a number of yellow pixels, a number of magenta pixels, a number of cyan pixels, and a number of black pixels in the top portion of the image data using the counter.

18. A control method of an image forming apparatus including image bearing members, has a function of monochrome printing for forming latent images corresponding to inputted image data on the image bearing members, developing the latent images on the image bearing members with a black developer, and transferring the developed images onto a leading end to a trailing end of a paper sheet, and has a function of color printing for forming latent images corresponding to the image data on the image bearing members, developing the latent images on the image bearing members with developers of plural colors, and transferring the developed latent images onto the leading end to the trailing end of the paper sheet, the control method comprising:
detecting numbers of pixels of the respective colors of the image data;
setting, in the monochrome printing, a print invalid area with first variable-width corresponding to a number of black pixels among the numbers of pixels of the respective colors detected by the detecting section in a top portion of the image data; and
setting, in the color printing, a print invalid area with second variable-width corresponding to a sum of the numbers of pixels of the respective colors detected by the detecting section in the top portion of the image data.
